(19) United States
(12) Patent Application Publication
(10) Pub. No.: US 2009/0299651 A1
(43) Pub. Date: Dec. 3, 2009

(54) FILTRATION TESTING SYSTEM

(75) Inventor: Michael James Sadar, Fort Collins, CO (US)

Correspondence Address: THE OLLILA LAW GROUP LLC, 2060 BROADWAY, SUITE 300, BOULDER, CO, 80302, US

(73) Assignee: Hach Company, Loveland, CO (US)

(21) Appl. No.: 12/129,368

(22) Filed: May 29, 2008

(51) Int. Cl. G01N 31/00; G21C 17/00; G06F 15/00

(52) U.S. Cl. 702/24; 702/185; 702/190

(57) ABSTRACT

A filtration testing system is provided. The filtration testing system includes one or more filtration systems configured for filtering a fluid. A filtration system of the one or more filtration systems includes one or more filter units. The filtration testing system further includes a gas detector configured to quantify gas in the fluid at a downstream side of the one or more filter units of the one or more filtration systems. The gas detector is configured to generate a gas quantification, compare the gas quantification to a predetermined gas characteristic, and detect a fault in the one or more filtration systems if the gas quantification exceeds the predetermined gas characteristic.

### BACKGROUND OF THE INVENTION

1. Field of the Invention

The invention is related to the field of filtration, and more particularly, to a filtration testing system.

2. Statement of the Problem

FIG. 1 shows a membrane filtration system 1 that is used for removing small particulate from liquids, such as water, for example. The membrane filtration system 1 is typically used for filtration of water in municipal water systems, such as for drinking water, wastewater, or industrial filtration processes, for example. The membrane filtration system 1 can receive water that is untreated or at least partially treated (such as a large-scale filtration) and the water can be passed through the membrane filtration system 1 in order to achieve a high level of particulate filtration.

The membrane filtration system 1 includes a processing chamber 2. An inlet conduit 3 can pass unfiltered water or other fluids into the processing chamber 2. An outlet conduit 4 can remove filtered water that has passed through the membrane filtration system 1. The inlet and outlet conduits 3 and 4 can further include valves, etc., for transporting and regulating the flow and pressure of fluids into and out of the membrane filtration system 1. The filtered water at the outlet conduit 4 can be transported to a water distribution system or can be transported to further treatment devices or processes. Upper and lower blocks 5 and 6 create a middle (i.e., working) chamber 7. The middle chamber 7 is located between an upper chamber 8 and a lower chamber 9. The lower chamber 9 communicates with the inlet conduit 3. The upper chamber 8 communicates with the outlet conduit 4. A plurality of fibrous membrane tubes 20, sometimes referred to as fibers, can extend between the upper and lower blocks 5 and 6. The fibers 20 typically are very small in diameter (such as down to between one and three millimeters, for example) and by comparison are very long, such as about three to ten feet long.

The membrane filtration system 1 can typically remove particulate down to about (0.1) micron in size. The membrane filtration system 1 can therefore remove both non-living particulate, including fine sediments, and can remove organisms, such as bacterium, viruses, cysts and oocysts, and other organic compounds. Filtration is based upon size exclusion principles.

The membrane filtration system 1 can include a large number of fibers 20. The fibers 20 can be formed of numerous compositions of semi-rigid materials that are substantially porous. The fiber 20 can be engineered to trap particles that are larger than water molecules. However, the fibers 20 can be designed to allow water molecules to pass through under pressure (such as at pressures of between 5 to 90 psi, for example). The fibers 20 of the membrane filtration system 1 can be densely packed and therefore the membrane filtration system 1 can process significant volumes of liquid. It should be understood that the greater the surface area on the influent side of a fiber, the greater the volume of filtered water that is produced.

FIG. 2 shows a portion of the membrane filtration system 1, illustrating a fluid flow path through the system. The fibers 20 can pass partially or completely through the upper block 5. The fibers 20 are received by the lower block 6 but do not pass through. Consequently, the fibers 20 are open to the upper chamber 8 but are not open to the lower chamber 9. A plurality of lower block passages 27 pass through the lower block 6 and allow unfiltered fluid to pass from the inlet conduit 3 up into the middle chamber 7.

In operation, water or other fluid is provided at a working pressure and is introduced into the membrane filtration system 1 through the inlet conduit 3. The pressurized water passes through the lower block passages 27 into the middle chamber 7. The water surrounds and immerses the fibers 20. The working pressure of the water forces water molecules through pores or openings in the fibers 20, passing into the interior of the fibers 20. However, most foreign matter cannot penetrate the walls of the fibers 20 and is subsequently retained at or on the outer surface of the fibers 20. Consequently, the foreign matter is removed from the water or fluid as it passes into the interior of the fibers 20. The filtered water is subsequently moved upward in the fibers 20 by the working pressure, into the upper chamber 8 and out of the outlet conduit 4.

Because the foreign matter, known as scale, cannot pass through the fibers 20, it remains on the outside of the fibers 20. Over time, this foreign matter will build up on the fibers 20 in a phenomena known as scaling, impeding further filtration. Periodically, the accumulated foreign matter must be removed.

One prior art approach to cleaning the fibers 20 is to circulate water or fluid around the outside of and between the fibers 20. However, this prior art approach does not effectively remove scale from the surface of fibers or interstitial spaces between the fibers 20.

Another prior art approach to cleaning the fibers 20 is termed an air scour. FIG. 3 shows a prior art air scour cleaning operation. The filtration cycle is suspended during the air scour cycle and air bubbles are injected into the middle chamber 7. The air bubbles impinge on the fibers 20 and work the accumulated scale off the fibers 20 and out of the interstitial spaces of the scale forming in between the fibers 20. The air bubbles will travel upward between the fibers 20. When the bubbling process is done, water in the middle chamber 7 is removed and the middle chamber 7 can be flushed in order to remove all scoured-off scale. A normal filtration operation can then resume. The air scour cleaning operation is periodically performed in order to keep the fibers 20 optimally clean.

One problem that can occur in the membrane filtration system 1 is a tear or other failure in a fiber 20. Another problem can be a crack or opening in either the upper block 5 or lower block 6 due to a failure of the block material, thermal expansion effects, manufacturing or material defects, etc. Further, a fiber 20 can pull out of an opening or aperture in one of the blocks 5 or 6. Any one of these failures can result in water passing through the membrane filtration system 1 without being filtered, wherein dangerous or undesired materials can be passed into a process stream of a municipal water system. Consequently, leakage tests have been developed in the prior art that detect leaks in the membrane filtration system 1.

One prior art leakage test comprises halting operation of a membrane filtration system 1 (or bank of systems) and pressurizing the membrane filtration system 1 with air and measuring a rate of pressure decay. The pressure is introduced into the lower chamber 9 and the middle chamber 7, but not the upper chamber 8. Therefore, a static pressure gradient is created between the outside and the inside of the fibers 20. If the static pressure decays too rapidly, leakage is occurring and a fault can be determined to exist somewhere in the membrane filtration system 1 (or bank of systems). Visual inspection of the interior of the upper chamber 8 can sometimes lead to pinpointing of the leakage or leakages. Conversely, if the pressure is substantially maintained over time, then it can be determined that there is no leakage.

However, the prior art leakage testing approach has drawbacks. The prior art leakage testing requires significant time to perform, as the pressure decay waiting period for a successful test may extend from fifteen to twenty-five minutes. This is prohibitively long when compared to thirty to sixty minutes for a typical filtration cycle and several minutes for a typical air scour cycle (typically about one minute of air scour combined with about one minute of reverse water flow to remove the dislodged scale). If a leakage is detected, particularly a high level of leakage, then the test may take less time, as a large leak will produce a fast and noticeable pressure drop. However, if leakage is detected, further testing may be required in order to pinpoint a specific filtration unit, where multiple filtration units 1 are employed and tested as a bank.

The prior art leakage testing requires adding a testing phase in between filtration and air scour phases. The prior art leakage testing therefore consumes valuable filtration time. As a result, leakage testing may be infrequently performed. The prior art leakage testing may be susceptible to false negatives due to leakage in the testing equipment. The prior art leakage testing may cause additional fatigue in the components of the system due to the air pressurization, possibly causing damage and leaks.

### SUMMARY OF THE INVENTION

A filtration testing system is provided. The filtration testing system comprises one or more filtration systems configured for filtering a fluid. A filtration system of the one or more filtration systems includes one or more filter units. The filtration testing system further comprises a gas detector configured to quantify gas in the fluid at a downstream side of the one or more filter units of the one or more filtration systems. The gas detector is configured to generate a gas quantification, compare the gas quantification to a predetermined gas characteristic, and detect a fault in the one or more filtration systems if the gas quantification exceeds the predetermined gas characteristic.

A gas detector configured for testing one or more filtration systems is provided. The filtration testing system comprises a gas detector unit configured to quantify gas in a fluid at a downstream side of one or more filter units of the one or more filtration systems and a processing system in communication with the gas detector unit. The processing system is configured to quantify the gas in the fluid at an upstream side of the one or more filter units and generate a gas quantification, compare the gas quantification to a predetermined gas characteristic, and detect a fault in the one or more filtration systems if the gas quantification exceeds the predetermined gas characteristic.

A method of testing one or more filtration systems is provided. The method comprises quantifying gas in a fluid at a downstream side of one or more filter units of the one or more filtration systems and generating a gas quantification. The method further comprises comparing the gas quantification to a predetermined gas characteristic and detecting a fault in the one or more filtration systems if the gas quantification exceeds the predetermined gas characteristic.

### DESCRIPTION OF THE DRAWINGS

The same reference number represents the same element on all drawings. It should be understood that the drawings are not necessarily to scale.

FIG. 1 shows a membrane filtration system that is used for removing small particulate from liquids, such as water, for example.

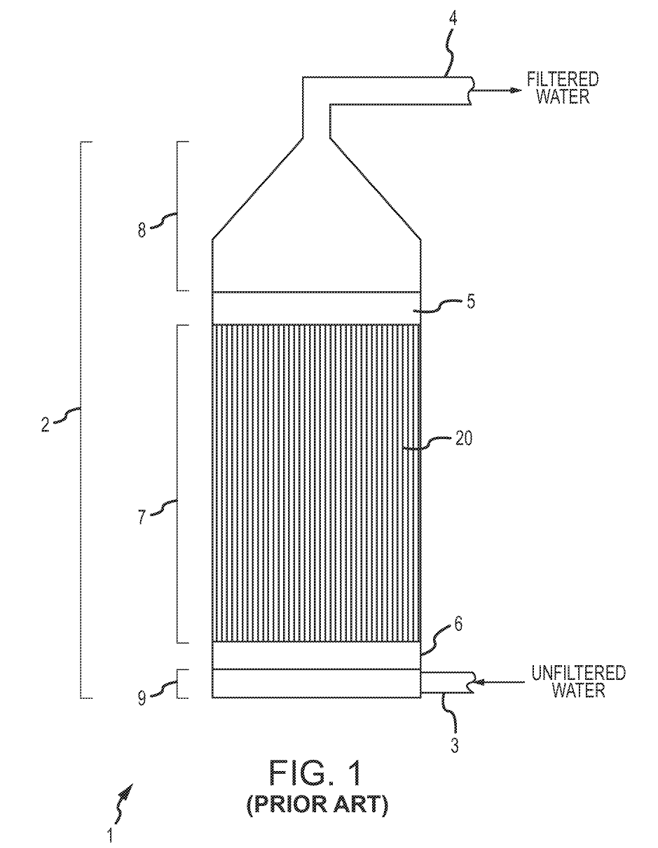

FIG. 2 shows a portion of the membrane filtration system, illustrating a fluid flow path through the system.

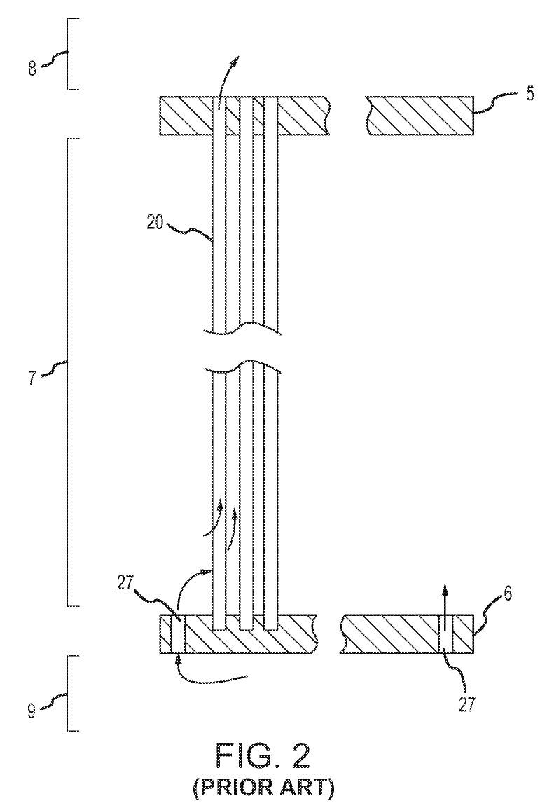

FIG. 3 shows a prior art air scour cleaning operation.

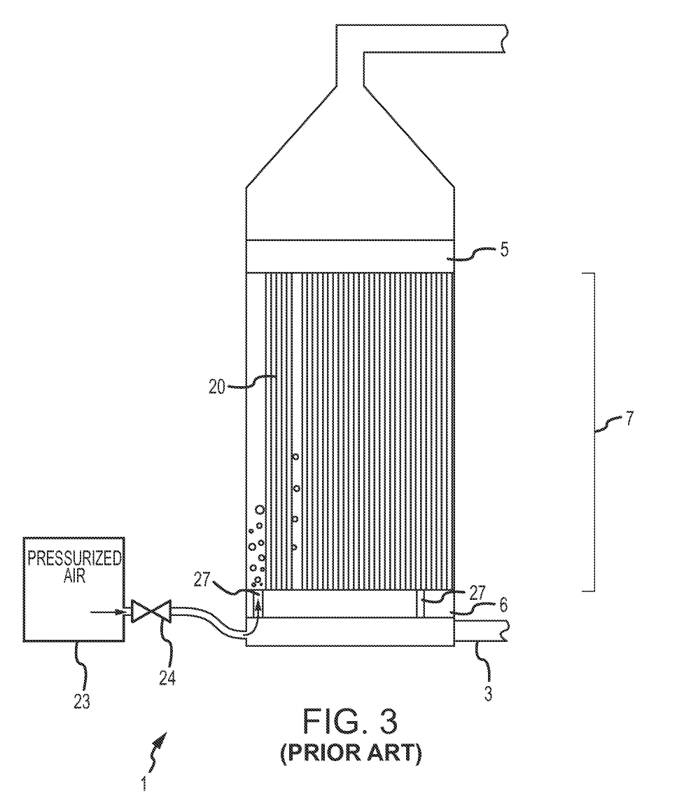

FIG. 4 shows a filtration system according to an embodiment of the invention.

FIG. 5 shows a portion of a middle chamber of the filtration system including one or more filter units according to an embodiment of the invention.

FIG. 6 is a flowchart of a method of testing a filtration system or systems according to an embodiment of the invention.

FIG. 7 shows detail of a gas detector according to an embodiment of the invention.

FIG. 8 shows the filtration system according to an embodiment of the invention.

FIG. 9 shows the filtration system according to an embodiment of the invention.

### DETAILED DESCRIPTION OF THE INVENTION

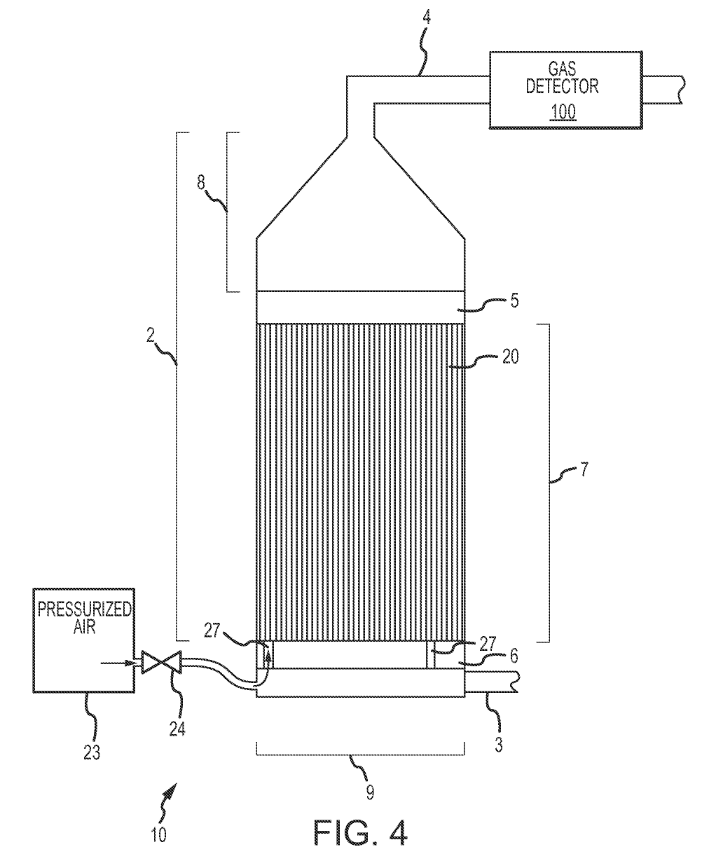

FIGS. 4-9 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 4 shows a filtration system 10 according to an embodiment of the invention. The filtration system 10 can comprise a membrane filtration system or can comprise any other filtration system. The filtration system 10 can comprise a filtration system that employs an air scour operation for cleaning. Alternatively, the filtration system 10 can comprise a filtration system that uses pressurized gas in some manner, and not necessarily just for a cleaning operation. For purposes of discussion, the figures and text discuss only a membrane filtration system for purposes of simplicity. For purposes of discussion, the figures and text discuss gas introduced during an air scour cleaning operation, but it should be understood that the gas can be introduced or present in the fluid for other reasons, including gases entering into the fluid at any point before the filtration. Further, although the filtration system 10 can be used for filtering various liquids, the discussion will center on water filtration for simplicity.

The filtration system 10 includes a filtration chamber 2, wherein an upper block 5 and a lower block 6 divide the filtration chamber 2 into an upper chamber 8, a middle (working) chamber 7, and a lower chamber 9. The filtration chamber 2 further includes an inlet conduit 3 and an outlet conduit 4. The inlet conduit 3 transports water (or other fluids to be filtered) into the lower chamber 9 of the filtration chamber 2 and the outlet conduit 4 transports filtered water away from the upper chamber 8. Water provided by the inlet conduit 3 is typically pressurized, such as from five to ninety pounds-per-square-inch (psi), for example.

The filtration system 10 can typically remove particulate down to about 0.1 micron in size. The filtration system 10 can therefore remove both non-living particulate, including fine sediments, and can remove organisms, such as bacterium, viruses, cysts and oocysts, and other organic compounds.

The filtration system 10 comprises one or more filter units 20. The filtration system 10 can include a large number of filter units 20. The filter units 20 can be formed of fibers and can therefore be substantially porous. Consequently, the filter units 20 can be designed to allow water molecules to pass through under pressure (such as at pressures of between 5 to 90 psi, for example). However, the filter units 20 can be engineered to trap particles that are larger than water molecules, for example. The filter units 20 of the filtration system 10 can be densely packed and therefore the filtration system 10 can process significant volumes of liquid.

The middle chamber 7 includes a plurality of filter units 20 that extend between and are held by the upper block 5 and the lower block 6. The filter units 20 in some embodiments comprise membrane tubes or fibers, as previously discussed. However, the filter units 20 can comprise any other manner of filtration surfaces or filtration devices. The filter units 20 in the embodiment shown comprise hollow tubes (or other shapes) that are at least partially porous, such as being porous to water molecules. The fibers 20 pass through or open to passages extending through the upper block 5. The fibers 20 are received in the lower block 6, but do not pass through the lower block 6. Consequently, fluid cannot pass from the lower chamber 9 directly into the interior of the filter fibers 20. However, the lower block 6 does include a plurality of lower block passages 27 that allow water to travel from the lower chamber 9 up into the middle chamber 7. The water therefore fills in around the fibers 20, but will not pass into the interiors of the filter units 20 without substantial pressurization.

Alternatively, the fibers 20 can comprise non-fibrous filter materials, including membranes or reverse-osmosis (RO) membranes. It should be understood that the one or more filter units 20 can comprise any manner of filtration modules including modules of different sizes and capacities.

When the water is pressurized, the water can pass through the walls of the filter units 20 and can subsequently travel upward through the fiber and into the upper chamber 8 and out of the outlet conduit 4. However, foreign matter in the water, such as particulate, including sediment, organic matter, viruses, bacteria, cysts and oocysts, for example, which combined are known as scale and generally cannot pass through the walls of the filter units 20 and are filtered out of the water. The filtered-out foreign matter is left in the middle chamber 7 as the filtered water travels up into the upper chamber 8.

The filtration system 10 in some embodiments can further include a pressurized air source 23 and valve 24 that are in communication with the filtration chamber 2, such as the lower chamber 9. The valve 24 can be operated to provide air bubbles into the lower chamber 9, wherein the air bubbles will move upward through the plurality of lower block passages 27 and into the middle chamber 7. The air bubbles will move between and around the plurality of filter units 20, generally moving upward. The air bubbles consequently will scour the filtered-out foreign matter or scale off the exterior surfaces of the filter units 20. This is termed an air scour operation. The air scour operation is periodically performed in order to keep the plurality of filter units 20 relatively clean and so that the filter units 20 will continue to efficiently filter the fluid at the designated pressures of about 5 to 90 PSI. For example, normal operation of the filtration system 10 can include a filtration phase that is periodically interrupted by an air scour phase. The air scour phase can be in simultaneous operation with a backwash phase, wherein the flow through the middle chamber 7 is reversed and/or flushed in order to remove the scale that has been scoured off the plurality of filter units 20 by the air scour operation.

In typical operation, and when experiencing typical foreign matter levels, a filtration cycle can last for thirty to sixty minutes. The filtration cycle is followed by an air scour cycle, with or without the backwash, of one to two minutes, and then the system can revert back to another filtration cycle.

The filtration system 10 according to the invention further includes a gas detector 100 in communication with liquid in the upper chamber 8 and/or liquid in the outlet conduit 4. The gas detector 100 is exposed to liquid that has been processed through the middle chamber 7. The gas detector 100 detects and quantifies gas passing out of the middle chamber 7 (such as bubbles, for example) and generates a gas quantification. The gas detector 100 can compare the gas quantification to a predetermined gas characteristic in order to detect or determine leakage in the filtration chamber 2. The gas detector 100 can use the gas quantification in order to detect a membrane fault in the filtration system 10, such as if the gas quantification exceeds the predetermined gas characteristic.

The gas detector 100 can detect and/or quantify gas that reaches the upper chamber 8 or the outlet conduit 4. The gas detector 100 can be positioned at any point downstream of the middle chamber 7. The gas detector 100 can detect gas that has therefore substantially freely passed through a leak, tear, gap, crack, or other fault in components of the middle chamber 7 including in the upper block 5 and the lower block 6. This free passage through a fault will result in an increase in the quantified gas in the filtrate stream.

The gas detector 100 can comprise an electromagnetic, optical, or acoustic gas or bubble detector. The gas detector 100 can comprise a motion detector of any type. The gas detector 100 can comprise a turbidimeter, nephelometer, or laser nephelometer. The gas detector 100 can generate a gas mass quantification, a gas volume quantification, an approximate bubble number quantification, an approximate bubble size quantification, and/or an approximate bubble travel speed quantification.

The gas quantification can comprise generating a gas volume or mass quantification. The gas quantification can comprise generating an approximate bubble number quantification. The gas quantification can comprise generating an approximate bubble size quantification. The gas quantification can comprise generating an approximate bubble speed quantification or determining the number of bubbles present in a given volume of filtrate. The gas quantification can comprise one or more of the above gas or bubble characteristics.

The predetermined gas characteristic can comprise any manner of leakage threshold that can indicate leakage in the filtration system 10. The predetermined gas characteristic can be determined in any manner, including from empirically or theoretically determined numbers.

If the bubble quantification exceeds the predetermined gas characteristic, then the gas detector 100 (or associated processing device) can generate a fault indication. The fault indication can include any manner of alarm or indication, including visual alarms, audible alarms, alarm messages including transmitted alarm messages, etc.

In some embodiments, the gas detector 100 can detect a particular gas, such as oxygen or other gases, including gas mixtures, for example. The gas detector 100 in some embodiments can detect a gas or gases at levels down to parts-per-billion (ppb) in the liquid, if desired. Consequently, the gas detector 100 can detect even very small leaks, depending on the pressure in the middle chamber 7 and the leakage test duration, where the test duration may be up to the length of the air scour cycle, for example.

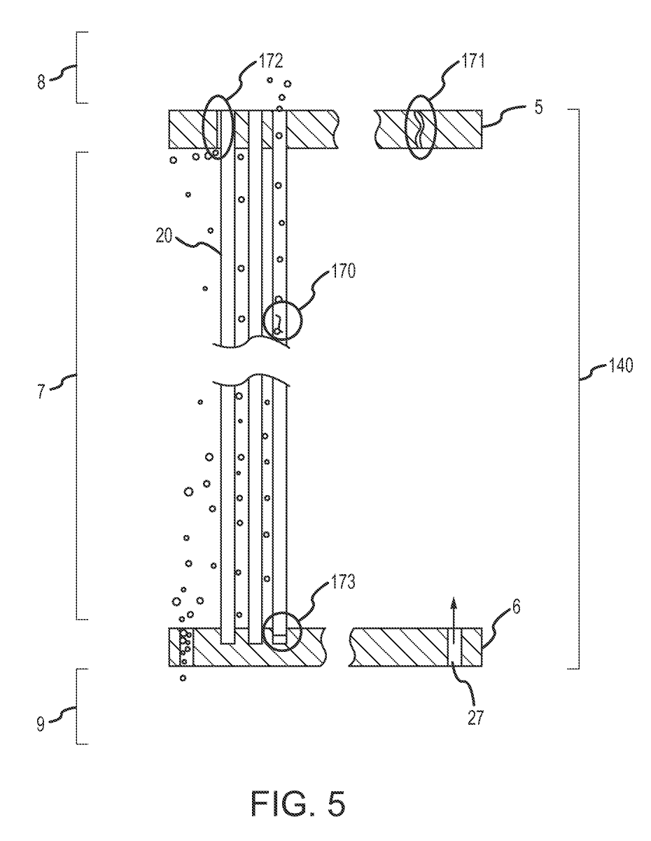

FIG. 5 shows a portion of the middle chamber 7 of the filtration system 10 including the one or more filter fibers 20 according to an embodiment of the invention. The upper block 5, the lower block 6, and the plurality of filter units 20 form a filtration assembly 140. This figure illustrates an air or gas flow path through the filtration assembly 140 and through typical defects or breaches in the filtration assembly 140.

During a filtration cycle, pressurized water or other fluid under filtration passes through the lower block passages 27 in the lower block 6 and into the middle chamber 7. The water therefore surrounds and immerses the filter fibers 20. The working pressure of the water forces water molecules through pores in the filter fibers 20, passing into the interior of the filter fibers 20. However, most foreign matter and undissolved air cannot penetrate the walls of the fibers and is retained at or on the outer surface of the filter fibers 20. Consequently, the foreign matter is removed from the water (or fluid) as it passes into the interior of the filter fibers 20. The filtered water is subsequently moved upward in the filter units 20 by the working pressure, into the upper chamber 8 and out of the outlet conduit 4.

Because the foreign matter cannot pass through the filter fibers 20, it remains on the outside of the filter fibers 20. Over time, this foreign matter will build up, impeding further filtration. Periodically, the accumulated scale must be removed by a cleaning process, such as an air scour operation or a simultaneously combined air scour reverse flow operation, for example. However, other cleaning or testing operations can also be employed.

According to some embodiments of the invention, a gas detector 100 can be employed during an air scour operation in order to detect any leakage in the filtration assembly 140. During an air scour operation, gas in the form of air bubbles is introduced into the middle chamber 7 through the plurality of lower block passages 27. The bubbles can be of any gas or gas mixture, but the discussion will refer to air for simplicity. The air bubbles can be introduced at a working pressure, which can be less than the fluid pressure used for a filtering operation. However, pressure can be used, including pressures higher than a fluid filtration working pressure. The air or gas will pass through any significant fault in the filtration assembly 140 and will travel into the upper chamber 8. The air or gas, whether in bubble form or dissolved in the liquid, will move generally upward due to its natural buoyancy.

If no leakage exists in the filtration assembly 140, then no air or gas will pass directly into the upper chamber 8 or the outlet conduit 4. The gas detector 100 will therefore not detect an appreciable quantity of air or gas.

The gas detector 100 in some embodiments is programmed with a leakage threshold in the form of a predetermined gas characteristic. The predetermined gas characteristic can include a predetermined gas volume or mass, for example. The predetermined gas characteristic can include a predetermined gas type or gas mixture type, for example. Other gas characteristics can be included in the predetermined gas characteristic.

A quantity of detected air or gas that is less than the predetermined leakage threshold will trigger a determination of no leakage. However, if air or gas is detected in quantities above the predetermined leakage threshold, then a determination of leakage will be made.

One such fault 170 is shown in the figure, with the fault 170 comprising a tear or hole in a filter fiber 20. Another fault 171 comprises a crack or fault in an upper or lower block 5 or 6 (shown at a large size for illustration). Yet another fault 172 can comprise a gap or space between a filter fiber 20 and an the upper block 6. Yet another fault 173 can comprise a partial pulling out of a filter unit 20 from the lower block 6.

The gas (i.e., gas leakage) detection can advantageously be performed during an existing air scour operation, if desired. The gas detection therefore does not require an additional and time-consuming process step, unlike the prior art. The gas detection can be performed in parallel with the air scour phase or combined air scour backwash phase. The gas detection can be performed frequently, such as at every air scour cycle, for example. However, the gas detection can be performed at any time and is not limited to an air scour operation, as previously discussed.

The gas detection is broader and more flexible than the pressurization test of the prior art. The gas detection can test for gas mixtures or a specific gas.

The gas detection does not stress or fatigue the filtration assembly by requiring high pneumatic pressures. The gas detection can be performed at a variety of pressures and over any desired time period in order to test for any anticipated leakage amount.

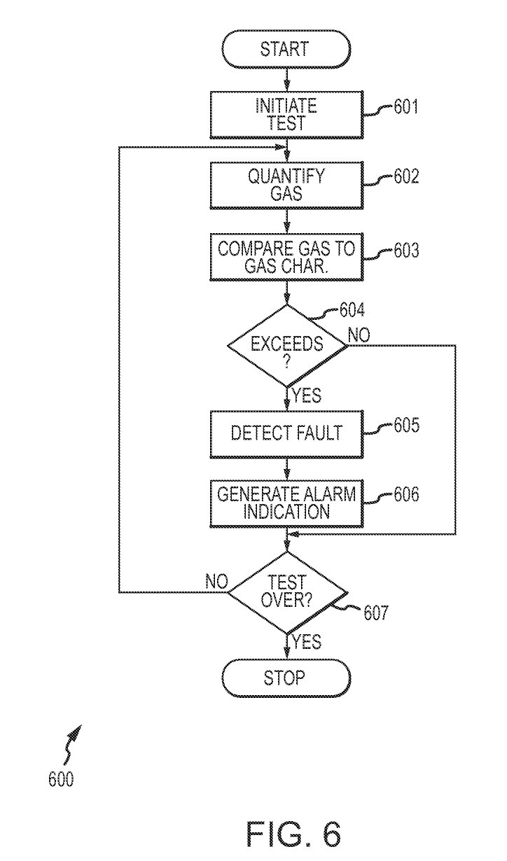

FIG. 6 is a flowchart 600 of a method of testing a filtration system or systems according to an embodiment of the invention. In step 601, gas is injected (or otherwise present) at an upstream side of the filtration system, i.e., before the fluid passes through one or more filter fibers of the filtration system. The one or more filter fibers comprise the upstream-downstream boundary. In some embodiments, the gas is present due to an air scour operation. The air scour operation injects gas into a fluid being filtered, generally during a non-filtration period. Alternatively, the gas can be introduced into the filtration system for other operations, including a pressurization test, for example. Gas can be introduced at any time.

In step 602, gas is quantified. The gas is any gas that has passed through the filtration system. In some embodiments, the gas has passed through the filtration system as a result of an air scour operation, including gas detected during and/or after the air scour operation. The fluid generally does not pass through during the air scour operation, although the test can be performed even when fluid flow through the filtration system or systems is occurring. Any desired amount of gas can be detected and quantified, including gas concentrations as low as parts-per-billion in the fluid.

In step 603, the gas quantification is compared to a predetermined gas characteristic. The predetermined gas characteristic can comprise an allowable or permissible level of gas in the fluid being filtered. The predetermined gas characteristic can be chosen or set according to the filter units used in the filtration system and can accommodate the porosity and strength of the filter units, for example.

In step 604, if the gas quantification exceeds the predetermined gas characteristic, then the method proceeds to step 605. However, if the gas quantification does not exceed the predetermined gas characteristic, then the method branches to step 607.

In step 605, a fault is detected. The fault is detected as a consequence of the gas quantification exceeding the predetermined gas characteristic, i.e., the amount of gas passing through the filtration system has exceeded an acceptable threshold. The fault can indicate that gas leakage is occurring within a filtration system. The fault can indicate that gas leakage is occurring in a filtration system of a bank or plurality of filtration systems. The amount of gas detected will correspond to the relative size of the leakage in the filtration system or systems.

In step 606, an alarm indication can optionally be generated. The alarm indication can comprise any manner of alarm indication, including audible or visual alarms, for example. In addition or alternatively, the alarm indication can include transmitting an alarm message to other persons, computers, or monitoring devices.

In step 607, the method checks to see if the gas leakage test is over (including if the air scour or air scour backwash is complete). If the gas leakage test is not over, then the method loops back to step 602 and the method continues to monitor for gas leakages. If the gas leakage test is over, then the method exits.

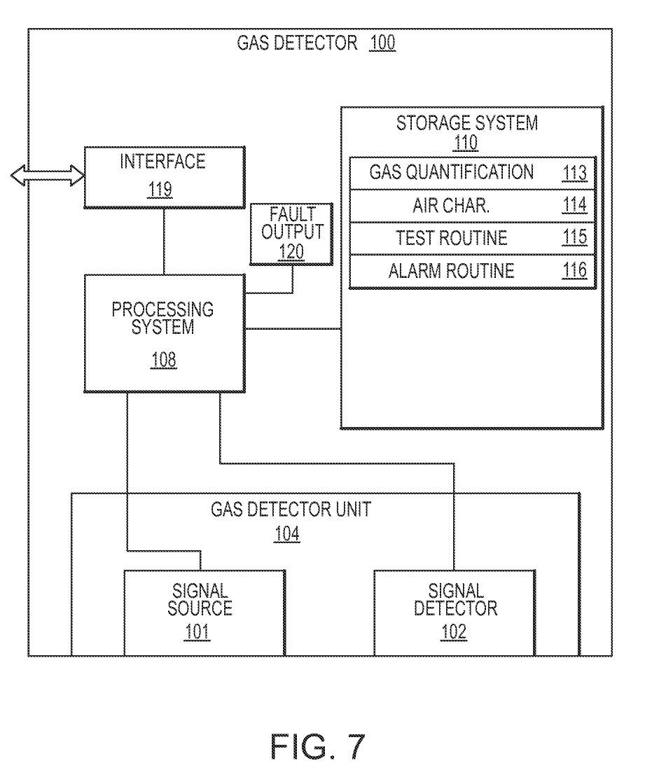

FIG. 7 shows detail of the gas detector 100 according to an embodiment of the invention. The gas detector 100 comprises a gas detector unit 104, a processing system 108, and a storage system 110. The processing system 108 is coupled to and in communication with the gas detector unit 104 and the storage system 110.

The storage system 110 is configured to receive and store data and values, such as working values that are used for gas detection. The storage system 110 can receive and store the gas quantification 113. The gas quantification 113 can comprise a substantially periodically sampled (or averaged) gas quantification or can comprise a substantially instantaneous gas quantification. The storage system 110 can receive and store a predetermined gas characteristic 114. The predetermined gas characteristic 114 in some embodiments comprises a threshold that is used to determine whether leakage is occurring. Other data can also be stored in the storage system 110.

The storage system 110 is configured to store software routines for execution by the processing system 108. For example, the storage system 110 can store a test routine 115 that performs a gas detection operation when executed by the processing system 108. The storage system 110 can further store an alarm routine 116 that processes a fault detection and/or performs alarm functions when executed by the processing system 108.

The processing system 108 receives the gas quantification, compares the gas quantification to a predetermined gas characteristic, and detects a fault in the filtration system 10 (or systems) if the gas quantification exceeds the predetermined gas characteristic. In addition, the processing system can retrieve the predetermined gas characteristic 114 from the storage system 110. Further, the processing system 108 can store a received gas quantification in the gas quantification 113 of the storage system 110.

The gas detector unit 104 generates a gas quantification of gas in the fluid. The fluid is located at a downstream side of the one or more filter units 20. The gas detector unit 104 can quantify a gas mass. The gas detector unit 104 can quantify a gas volume. The gas detector unit 104 can quantify gas bubbles, including one or more of a bubble size, a number of bubbles, and/or a speed of movement of the bubbles.

The gas detector unit 104 can quantify the gas using light, including measuring light that is reflected, transmitted, or scattered by the gas in the fluid. The gas detector unit 104 can quantify the gas using electromagnetic waves, including measuring electromagnetic waves that are reflected, transmitted, or scattered by the gas in the fluid. The gas detector unit 104 can quantify the gas using acoustic waves, including measuring acoustic waves that are reflected, transmitted, or scattered by the gas in the fluid.

In some embodiments, the gas detector unit 104 comprises a signal source 101 and a signal detector 102. The signal source 101 transmits a quantification signal into the fluid. The quantification signal can comprise a light signal, an electromagnetic signal, or an acoustic signal, as discussed above. The signal detector 102 quantifies the quantification signal received through the fluid.

The gas detector 100 can further include an interface 119 that is in communication with the processing system 108. The processing system 108 can use the interface 119 to communicate with other devices, including remote devices. The processing system 108 can use the interface 119 to communicate with persons, including monitoring technicians. For example, an alarm condition can be relayed using the interface 119.

The gas detector 100 can further include a fault output 120 that is in communication with the processing system 108. The fault output 120 can comprise an audible fault output. The fault output 120 can comprise a visual fault output, including lights, displays, etc. In some embodiments, the processing system 108 can activate the fault output 120 when a fault is detected in one or more filtration systems. Consequently, an operator can be notified that some manner of leakage has been detected.

It should be understood that any of the various embodiments can include the signal source 101 and the signal detector 102 of FIG. 7.

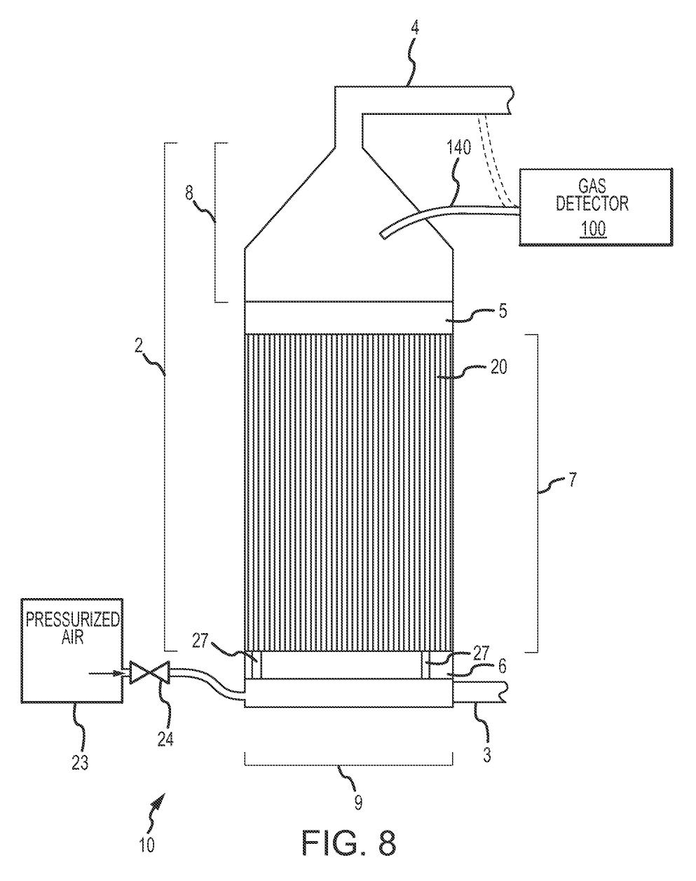

FIG. 8 shows the filtration system 10 according to an embodiment of the invention. In this embodiment, the gas detector 100 is in communication with the upper chamber 8 via a sampling conduit 140. The gas detector 100 therefore can sample and analyze a portion of the fluid and can detect gas passing up out of the filtration assembly 140. Alternatively, the sampling conduit 140 can be in communication with a portion of the outlet conduit 4, including with the outlet conduit 4 leading just from the individual filtration system 10 or from a conduit portion joined to multiple filtration systems 10. The gas detector 100 therefore can serve to detect gas and determine leakage in one or more banks of filtration devices, wherein each bank can be formed of multiple filtration systems 10.

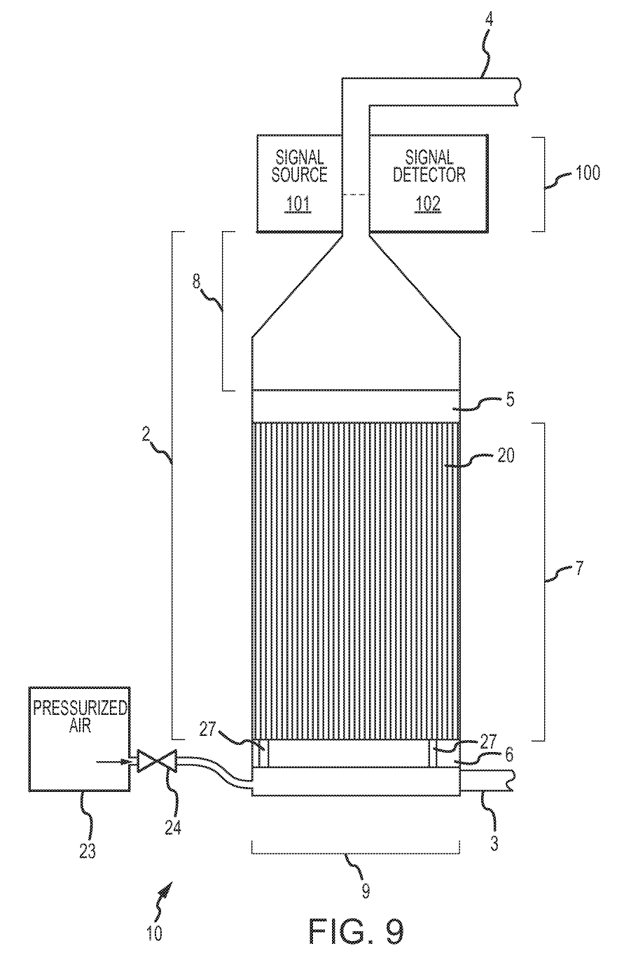

FIG. 9 shows the filtration system 10 according to an embodiment of the invention. In this embodiment, the gas detector 100 can be located adjacent to the upper chamber 8. For example, in one embodiment the gas detector 100 comprises a signal source 101 and a signal detector 102, wherein the signal source 101 generates a testing signal through a portion of the upper chamber 8 and the signal detector 102 receives at least a portion of the testing signal. The signal detector 102 determines the presence and quantity of gas in the upper chamber 8 from the testing signal. The signal source 101 and the signal detector 102 therefore can detect gas or gas bubbles in the upper chamber 8, in the outlet conduit 4, or in any downstream location.

In some embodiments, the signal source 101 and the signal detector 102 can comprise optical devices that employ light to detect gas and/or bubbles. For example, the signal source 101 can direct light radiation into the fluid and the signal detector 102 can detect light transmission, absorption, reflection, refraction, or scattering in order to detect gas and/or bubbles. Alternatively, the signal source 101 and the signal detector 102 can detect the effects on the gas/bubbles on predetermined wavelengths of light. In another embodiment, the signal source 101 and the signal detector 102 can detect and/or quantify the number of passing bubbles.

In some embodiments, the signal source 101 and the signal detector 102 can comprise devices that use electromagnetic waves to detect gas. For example, the signal source 101 can generate electromagnetic radiation into the fluid and the signal detector 102 can detect transmission, absorption, reflection, refraction, or scattering of the electromagnetic waves in order to detect gas and/or bubbles. The electromagnetic waves can comprise any useful wavelength.

In some embodiments, the signal source 101 and the signal detector 102 can comprise devices that use acoustic waves to detect gas. For example, the signal source 101 can generate acoustic signals into the fluid and the signal detector 102 can detect transmission, absorption, reflection, refraction, or scattering of the acoustic signals in order to detect gas and/or bubbles. The acoustic signals can comprise sonic, sub-sonic, and ultra-sonic waves, for example.

The signal source 101 and the signal detector 102 can be located at or be a part of a component of an individual filtration system 10, as shown. In this manner, any leakage within the filtration system 10 can be detected. Alternatively, the signal source 101 and the signal detector 102 can be located downstream of one or more such filtration systems 10. Additional valves or other mechanisms may need to be operated in order to detect leakage from among multiple filtration systems.

We claim:

1. A filtration testing system (10), comprising:
one or more filtration systems (10) configured for filtering a fluid, with a filtration system (10) of the one or more filtration systems (10) including one or more filter units (20); and
a gas detector (100) configured to quantify gas in the fluid at a downstream side of the one or more filter units (20) of the one or more filtration systems (10) and generate a gas quantification, compare the gas quantification to a predetermined gas characteristic, and detect a fault in the one or more filtration systems (10) if the gas quantification exceeds the predetermined gas characteristic.

2. The filtration testing system (10) of claim 1, with the gas detector (100) comprising:
a gas detector unit (104) configured to quantify the gas; and
a processing system (108) in communication with the gas detector unit (104) and configured to compare the gas quantification to the predetermined gas characteristic and detect the fault in the filtration system if the gas quantification exceeds the predetermined gas characteristic.

3. The filtration testing system (10) of claim 1, with the gas detector unit (104) comprising:
a signal source (101) configured to transmit a quantification signal into the fluid; and
a signal detector (102) that receives at least a portion of the quantification signal from the fluid, wherein the gas detector (100) quantifies the gas using the received quantification signal.

4. The filtration testing system (10) of claim 1, with the processing system (108) being further configured to generate a fault indication if the gas quantification exceeds the predetermined gas characteristic.

5. The filtration testing system (10) of claim 1, further comprising a fault output device (120) that generates a fault indication if the gas quantification exceeds the predetermined gas characteristic.

6. The filtration testing system (10) of claim 1, with the gas detector (100) comprising an electromagnetic gas detector.

7. The filtration testing system (10) of claim 1, with the gas detector (100) comprising an optical gas detector.

8. The filtration testing system (10) of claim 1, with the gas detector (100) comprising a turbidimeter.

9. The filtration testing system (10) of claim 1, with the gas detector (100) comprising a nephelometer.

10. The filtration testing system (10) of claim 1, with the gas detector (100) comprising an acoustic gas detector.

11. The filtration testing system (10) of claim 1, with the gas detector (100) generating a gas mass quantification.

12. The filtration testing system (10) of claim 1, with the gas detector (100) generating a gas volume quantification.

13. The filtration testing system (10) of claim 1, with the gas detector (100) comprising an acoustic bubble detector.

14. The filtration testing system (10) of claim 13, with the gas detector (100) generating an approximate bubble number quantification.

15. The filtration testing system (10) of claim 13, with the gas detector (100) generating an approximate bubble size quantification.

16. The filtration testing system (10) of claim 13, with the gas detector (100) generating an approximate bubble travel speed quantification.

17. A gas detector (100) configured for testing one or more filtration systems (10), comprising:
a gas detector unit (104) configured to quantify gas in a fluid at a downstream side of one or more filter units (20) of the one or more filtration systems (10); and
a processing system (108) in communication with the gas detector unit (104) and configured to
quantify the gas in the fluid at an upstream side of the one or more filter units (20) and generate a gas quantification,
compare the gas quantification to a predetermined gas characteristic, and
detect a fault in the one or more filtration systems (10) if the gas quantification exceeds the predetermined gas characteristic.

18. The gas detector (100) of claim 17, with the gas detector unit (104) comprising:
a signal source (101) configured to transmit a quantification signal into the fluid; and
a signal detector (102) that receives at least a portion of the quantification signal from the fluid, wherein the gas detector (100) quantifies the gas using the received quantification signal.

19. The gas detector (100) of claim 17, with the processing system (108) being further configured to generate a fault indication if the gas quantification exceeds the predetermined gas characteristic.

20. The gas detector (100) of claim 17, further comprising a fault output device (120) that generates a fault indication if the gas quantification exceeds the predetermined gas characteristic.

21. The gas detector (100) of claim 17, with the gas detector (100) comprising an electromagnetic gas detector.

22. The gas detector (100) of claim 17, with the gas detector (100) comprising an optical gas detector.

23. The gas detector (100) of claim 17, with the gas detector (100) comprising a turbidimeter.

24. The gas detector (100) of claim 17, with the gas detector (100) comprising a nephelometer.

25. The gas detector (100) of claim 17, with the gas detector (100) comprising an acoustic gas detector.

26. The gas detector (100) of claim 17, with the gas detector (100) generating a gas mass quantification.

27. The gas detector (100) of claim 17, with the gas detector (100) generating a gas volume quantification.

28. The gas detector (100) of claim 17, with the gas detector (100) comprising an acoustic bubble detector.

29. The gas detector (100) of claim 28, with the gas detector (100) generating an approximate bubble number quantification.

30. The gas detector (100) of claim 28, with the gas detector (100) generating an approximate bubble size quantification.

31. The gas detector (100) of claim 28, with the gas detector (100) generating an approximate bubble travel speed quantification.

32. A method of testing one or more filtration systems, comprising:
quantifying gas in a fluid at a downstream side of one or more filter units of the one or more filtration systems and generating a gas quantification;
comparing the gas quantification to a predetermined gas characteristic; and
detecting a fault in the one or more filtration systems if the gas quantification exceeds the predetermined gas characteristic.

33. The method of claim 32, with the quantifying comprising generating a gas mass quantification.

34. The method of claim 32, with the quantifying comprising generating a gas volume quantification.

35. The method of claim 32, with the quantifying comprising generating an approximate bubble number quantification.

36. The method of claim 32, with the quantifying comprising generating an approximate bubble size quantification.

37. The method of claim 32, with the quantifying comprising generating an approximate bubble travel speed quantification.

38. The method of claim 32, wherein the testing tests a plurality of filtration systems each including one or more filter units.

39. The method of claim 32, further comprising generating a fault indication if the gas quantification exceeds the predetermined gas characteristic.
